(19) United States
(12) Patent Application Publication
(10) Pub. No.: US 2023/0407158 A1
(43) Pub. Date: Dec. 21, 2023

(54) A DUST CONTROL SUBSTANCES-SOLUTION AND HOW IT IS TO BE APPLIED

(71) Applicant: Nano Z Coating, Ltd., Yavne (IL)

(72) Inventor: Ofer LEVY, Holon (IL)

(21) Appl. No.: 18/250,707

(22) PCT Filed: Dec. 14, 2021
(86) PCT No.: PCT/IL2021/051489

§ 371 Date: Apr. 26, 2023

Related U.S. Application Data
(60) Provisional application No. 63/126,542, filed on Dec. 17, 2020.

(51) Int. Cl. C09K 3/22

(52) U.S. Cl. CPC C09K 3/22

(57) ABSTRACT

The invention is a dust control substances-solution (DCSS). The invention discloses the substances the DCSS is made of, how they are to be mixed and how the DCSS is to be applied. The DCSS is based on treated soft wood particles and substances that form a layer oved dust covered surfaces. The layer “traps” water that is applied to the surface, thus, maintaining the dust in aggregates and prevents its raising to the air.

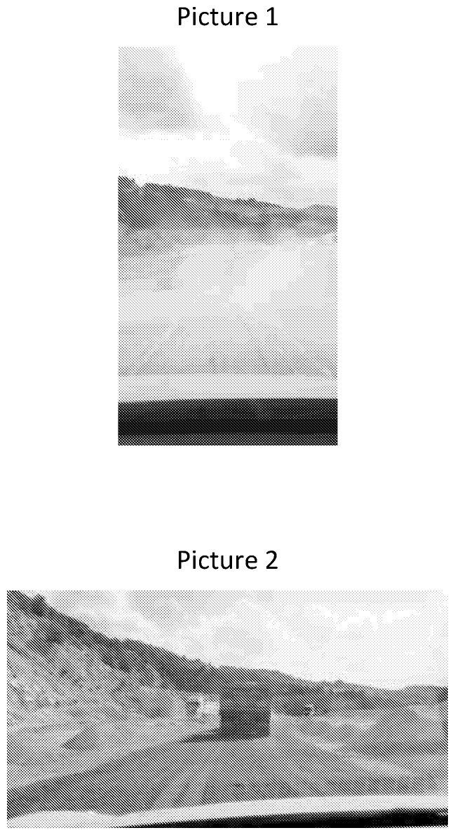

### FIELD OF THE INVENTION

The present invention relates to a dust control substances-solution (DCSS) and how it is to be applied. More specifically, the present invention relates to the substances of the DCSS, the procedure of mixing the substances and the procedure of applying the DCSS which is based on treated soft wood particles and is environmentally friendly.

### BACKGROUND OF THE INVENTION

Particles of any substance that are less than 10 micrometers in diameter (commonly referred to as PM-10) can be drawn deep into the lungs and tend to remain there. Exposure to such particles can affect both lungs and heart. Numerous scientific studies have linked particle pollution exposure to a variety of problems, including: premature death in people with heart or lung disease, nonfatal heart attacks, irregular heartbeat, aggravated asthma, decreased lung function, and increased respiratory symptoms, such as irritation of the airways, coughing or difficulty breathing.

The air contamination with particles smaller than PM-10 and technologies to reduce the contamination has received significant attention in recent years. The contamination of smaller than PM-10 particles is especially severe in place that emit enormous amounts of particles such as quarries, mines dirt roads, construction sites and places of processing and burial of solid wastes. The location of major dust producers in the vicinity of populations possess health threats to these populations. In addition to the health threat to the human population, the dust poses a threat to animals in the effected areas.

A major source of smaller than PM-10 particles are dirt roads leading to and from mines and quarries located near populated areas. The heavy vehicle that serve the mines and quarries have an abrasive and crushing effect on the upper ground layer, causing the destruction of the road-substance. The crushed substance is reduced to dust which has a large concentration of smaller than PM-10 particles. The formed dust is dispersed by the wind, the dispersion being dependent on meteorological and environmental factors and can reach and effect populations a great distance from the source of the dust.

In addition to the health hazards caused by the smaller than PM-10 particles, concentrated dust composed of particles both larger and smaller than PM-10 cause poor visibility and may significantly damage natural and farm-grown vegetation as well as water reservoirs. The suppression of raising dust is referred from hereafter as “dust control”. Over the years various technologies and materials have been introduced for unpaved road dust control. Suppressants used to control dust on unpaved roads can range from water to a large variety of compounds including brine solutions based on sodium chloride (NaCl), calcium chloride (CaCl₂)), and magnesium chloride (MgCl₂). While lignosulfonate, bitumen emulsions, as well as various resins, cellulose, starch and other sugar-based compounds and polymers may also be used, chloride solutions are the predominant dust control option in most regions since they are inexpensive, readily available and the other listed options require expensive infrastructure preparations for their use. An example of the required infrastructure preparation: the dust covered road is plowed to a depth of 70 cm, than sprayed with the dust control solution, and compacted with soil compactors of different types. A maintenance of spraying more of the solution is required from once a day to once a week depending on the substance and the environment. Water is most commonly used as a temporary dust suppressant on construction sites in gravel pits, mines and quarries. Although water moisture helps bind the fine-particles to prevent dust, it must be applied frequently to maintain adequate moisture. This means high labor and equipment costs, particularly under arid conditions where water is often scarce and evaporates quickly. The introduction of massive amounts of various brines as well as bitumen emulsions to the environment may cause serious contamination problems (sources of information: US Smithsonian magazine and US EPA publications).

In addition to brines, bitumen emulsions and the other dust control compounds previously mentioned, the use of ionic surfactant wetting solutions as dust control solutions was previously disclosed (such as described in U.S. Pat. No. 6,124,365, CN103242805, CN104559931). These solutions did not gain wide popularity.

The present invention is a dust control substances-solution (referred interchangeably as DCSS) that is composed of various chemical substances and includes treated soft wood particles. The DCSS of the invention is environment-friendly, composed of non-toxic materials, is easy to apply, requires little maintenance after application and its effect is relatively long lasting.

The aims of the DCSS of the invention is to reduce water consumption and dust dispersion, especially the PM-10 particles, from heavily used dirt roads in a manner that is superior to previously disclosed substances and technologies.

### SUMMARY OF THE INVENTION

The present invention relates to a dust control substances-solution (DCSS) and how it is to be applied. More specifically, the present invention relates to the substances of the DCSS, the procedure of mixing the substances and the procedure of applying the DCSS which is based on treated soft wood particles and is environmentally friendly. The DCSS is spread on dusty soil surfaces and, with the aid of water, forms a non-toxic, environment friendly soft wood-particles layer that covers the dust on the soil surface, preventing it from dispersing into the environment. The spreading can be done (but not limited to) using commercial beef-feed trucks\mulch spread devices\compost spreaders\motor grader blade. The spread layer forms a wood particles covering layer that is homogenous and completely covers the relevant dust covered soil area.

The invention is based on the phenomena that water-moisture on the top layer of dust covered soil causes the aggregation of the dust particles, thus, prevents the raising of the particles into the air. In the invention, particles of soft wood are exposed to and absorb a specific solution of chemical substance, forming the DCSS. The chemical substance (listed in the text that follows) are hydrophilic with the exception of the proprietary, commercially available, WO-100 substance which is a nano-particles liquid silicon dioxide mixture and is hydrophobic. The WO-100 is added in a relatively small amount. In implementation, the CSS is spread over a dust covered soil and water is sprayed over the spread layer. The water seeps through the DCSS layer. A small part of the water is absorbed in the wood capillaries and the large majority descends to the upper soil layer and is absorbed in it. The water/moisture that penetrates through the DCSS layer is “trapped” and preserved by the physical layer of wood particles above it. The hydrophobic W-100 substance in the wood particles repel water/moisture thus maintain the moisture in the soil over time. The layer structure of the wood particles, when having the required thickness, produces double insulation and blockage. From the outer-surface side the DCSS layer blocks the UV radiation and IR radiation that heats and dries both the wood particles and the top layer of soil and from the inner-surface side, the DCSS blankets the dust on the soil and inhibits the transfer of moisture from the soil outwards. Combining these features allows the high humidity under the DCSS layer to be maintained and in so forming dust particles aggregates, thus eliminating its ability of the dust to rise into the air.

The DCSS layer delays the water evaporation, thus, enabling the preservation over time a large volume of water that would have been otherwise needed and saves the labor that would have been required for spraying of the water. The DCSS is especially useful in locations where mining operations typically take place in an environment that reaches to 35 degrees Celsius and above and 50% and less humidity.

In deployment, the DCSS is spread in a layer having a thickness (but not limited to) between 1 and 10 centimeters over the dusty soil surface, depending on the thickness of the treated dust layer and the characteristics of the dust (the size of the particles as well as their chemical characteristics) as well on the environmental conditions (temperature and humidity). The size of the dust particles depends to a large extent on the number of trucks and their weight, that pass regularly on the dirt-road to be treated. In dry locations, the more trucks and more weight that pass on a dirt-road, the more the likely there will be much dust composed of fine particles.

In each location where the DCSS is to be applied the thickness and wetting regime of the spread layer has to be experimented with and determined from experience. Typically, the thickness of the initial, experimental layer, is 2-3 centimeter thick.

Presently, the substances in the DCSS and the percentage range of the use of each substance, calculated as part of the total weight of the DCSS, are listed below. The %-amount of each of the substances (including the wood particles) in the DCSS listed below is not strictly defined/restricted and can vary, depending on the availability and prices. The term: coloring agent” is used interchangeably in the text with the term “dye substance”.
Glycerin, between 25%-45%,
Propylene glycol, between 5%-10%,
WO-100 between 0.05% and 0.15%
A (substance) mixture of borate substances, between 8% and 12%
A water-soluble coloring agent, between 0.01% and 5%,
Water, between 0.3% and 0.7%,
Soft wood particles between 55% and 65%.

Presently the characteristics of the substances of the DCSS are provided: The chemicals glycerin (glycerol) and the propylene glycol can separately or together be of various purity grades, depending on the availability and prices. The relevant purity grades are: technical grade, food grade, cosmetic, analytical grade and pharmaceutical grade.

WO-100 is a nano-particles liquid silicon dioxide mixture. Nano-size particles are defined as particles having a diameter between 1 and 100 nm WO-100 is a proprietary product, sold by the Nano-Z-Coating Ltd Company.

Address of the company:
1 Shedlovski St. Yavne, Israel 8122101
Tel.: +972-3-7166565
email: nanot862@gmail.com.
(website: www.nanortec.com).

The borates (substance) mixture mentioned above is composed of four substances being of chemical grade or analytical grade quality: 35% B₂O₃, 40% Potassium octaborate, 5%, 2-aminoethanol and 10% monoester with boric acid. Each of the borate substances can be in a powdered form or as liquid solution. The total amount to be added to the DCSS of each of the four substances in the mixture is to be calculated in respect to the % of the borate mixture. An example: if the % of the total borates substance is 10% of the DCSS then, the amount of each of the four substances to be added will be (respectively) 3.5%, 4%, 1.5% and 1%. The borate mixture acts as a fire retardant additive

The water-soluble coloring agent used in the DCSS may be (but not limited to): natural plant-based colorants dyes, azo pigments and dyes, glycoazodyes, Brilliant Blue FCF and lake colors and dyes. The color-intensity of the dye of the DCSS serves as an indicator of the concentration of the other chemical substance (not including the wooden particles) in the spread layer. The fading of the dye signals that the (other) chemical substance have been washed out of the spread layer and they have to be replenished.

The water used in preparing the DCSS liquid solution as well as for the treatment of the wood particles can be either hard or soft water and can be in purity grade ranging from potable water to recycled/reclaimed water and/or a mixture of.

The characteristics of the wood particles are presently given: The term “soft wood” generally applies to trees that have a microstructure in which the entire tissue (the cells of the biomass) of the trunk of the tree acts as conduits and feed nutrients and water throughout the tree. Softwoods are generally used to produce paper pulp, cardboard, textiles, furniture, construction, and may more products.

The source of the softwood particles typically used for the production of DCSS can, but not limited to, belong to trees of the type: Fir, Pine, Populus, Spruce and Cypresses.

In the present text the term “soft wood particles” includes particles from the biomass of palm trees (typically, but not limited to coir).

In the DCSS, the soft wood particles used (of a single type or a mixture of types) are particles having a maximum length that ranges between 3 mm and 80 mm (the other two dimensions in the particles smaller than the length). The wood particles used can be of a single-type or mixture derived from various types of soft wood particle sources without giving a preference to any source of the particles.

The DCSS is produced by mixing the liquid solution composed of the listed above chemical substance with the wood particles.

The procedure of production of the DCSS is presently given:

The production of the DCSS is divided into three separate formulating stages prior to adding the wood particles. The solutions in each stage have to be thoroughly mixed. Producing of solution number 1—by mixing water soluble coloring agent into water.

Producing of solution number 2—mixing WO-100 into glycerin, then adding solution 1 to solution 2.

Producing solution 3 by mixing borate mixture substance (or adding the bromate substances in the mixture individually) into propylene glycol and adding solution 2 to form solution number 3.

Adding solution 3 to the wood particles and nd thoroughly mixing.

The DCSS is now ready for use. The DCSS can be spread by either (but not limited to) by a: commercial beef feed truck, a mulch spread device, a motor grader. or a compost spreader.

After applying the DCSS to the ground-surface a dose of water is sprayed over the DCSS layer. The spraying of the water maintains the moisture in the spread layer and the soil layer beneath it. The dose of water to be sprayed should be such as not to cause flooding of the DCSS layer. Typically 4 liters per square meter is used. The spraying is done by using a surface-spraying equipment.

After the applying of the DCSS layer and the initial water spraying, the DCSS layer is wetted by repeated water spraying, typically 4 liters per square meter. The wetting is done every 3 to 5 days, depending on the environment conditions surrounding the DCSS layer (ranging from dry and/or sun-blazed to moist and overcast environments) and can change from one wetting session to another. After approximately 30 rounds of water spraying (typically between 90 and 150 days) the DCSS is to be replenished.

The DCSS replenishment is done by spraying the initial, on the DCSS layer with a solution of diluted DCSS solution consisting of the substances listed above without including the wood particles. Typically 4 liters per square meter are sprayed. In the dilution, the original % weight calculation solution of all the substances is diluted by approximately 20% DCSS solution approximately 80% water (plus-minus 5% in the percentages of the dilution)). After the replenishment layer is applied, the water wettings every 3 to 5 days are resumed. The repeated wetting (spraying of water) of the DCSS layer is done as needed to maintain the DCSS in a moist state and, as previously stated, depends on the environmental conditions. The efficiency of the dust control is a function of the concentration of the chemical-substances of the DCSS in the dust covering layer. The repeated spraying of water over the DCSS layer gradually washes away the DCSS chemical substance from the wood particles as well as the dye thus, causing the color intensity of the dye to fade. The fading of the dye is directly correlated with the washout of the substances of the DCSS and indicates a reduction of the dust suppression of the layer of wood particles. The intensity of the dye serves as a rough/basic indicator of the state of the DCSS condition. It is understood that the degree of fading of the dye is a subjective evaluation by an observer, thus, the term “fading” is not a an exact determination and refers to a decrease in the intensity of the dye to a degree that a subjective observer can determine that the color change is substantial and is on the verge of disappearing.

Optionally, quantifying the fading of the dye is done by comparing the color of the DCSS layer to a color reference-chart. The color reference-chart is composed of images presented in a gradual color fading sequence. Each of the images is correlated with a concentration of the dye-substance remaining in the DCSS in the dust-covered layer. The reference chart provides indication from what fading color image the substances concentration of the DCSS are no longer effective in dust suppression. An appropriate (different) color chart will be provided to fit the type of dye used in the composition of the DCSS.

### Brief Description of the Pictures

Picture No. 1) is a photograph of the untreated dirt road in the query of Hartuv (near the Town of Beit Shemesh in Israel) in October 2021.

Picture No. 2) is a photograph of the same dirt road shown in picture 1 in October 2021 a day after picture No. 1 was taken and after applying the dust control substances-solution (DCSS) of the invention.

### A DETAILED DESCRIPTION OF A PREFERRED EMBODIMENT

The characteristics of the environmentally friendly dust control substances-solution (DCSS) of the invention were previously described. Presently a preferred embodiment of the production procedure of the DCSS is provided.

The preferred DCSS is composed (given in % by weight) of:
Glycerin, 22.5% cosmetic grade,
A mixture of borates substances of chemical grade, 10%,
Propylene-glycol: 7.5% cosmetic grade,
WO-100, 0.1%,

A mixture of soft wood particles of pine palms and poplar type trees, 59.3% The particles in a mixture of a size-range between 5 and 20 mm, all of one size or of a random mixture of sizes.
Water: 0.5%,
Coloring agent: Brilliant Blue FCF 0.1%

The production of the DCSS solution is divided into three separate forming stages prior to adding the wood particles:
Producing of solution No. 1—by mixing water soluble dye Brilliant Blue FCF into water.
Producing of solution No. 2—thoroughly mixing WO-100 into the glycerin, then adding solution 1 to solution 2 and mixing.
Producing solution No. 3 by mixing the borates substance into the propylene glycol and adding solution No. 2 to form solution No. 3 and mixing,
Mixing solution No. 3 with the wood particles.
The DCSS in now ready for use.

In deployments the DCSS is typically spread in a 1 inch\2.5-centimeter-thick layer on the treated ground-surface. The DCSS is typically sprayed at 4 liters per square meter. Following the spreading of the DCSS, the layer is typically sprayed with 4 liters of the water per each square meter. The spraying of the water is repeated every 3 to 5 days. After approximately 30 rounds of water-wetting of the DCL, in order to enhance the DCSS dust compression efficiency (and likewise to enhance the dye substance), the DCSS layer is sprayed with a diluted (typical. but not limited to) 20% solution, 80% water) DCSS solution composed of the substances of the original DCSS without the wood particles, typically at a dose of approximately 4 liters per square meter.

The intensity of the dye substance in the spread DCSS is a rough indicator of the state of the DCSS. The fading of the strong blue of the Brilliant Blue FCF dye indicts the washout of the substances of the DCSS from the dust control layer.

Pictures 1 and 2 visually illustrate the effectiveness of utilizing the DCSS on dust covered dirt roads.

Picture No. 1 is a photograph from the front window of a car that travels behind a vehicle (not visible because of the dust) on the untreated dirt road in the query of Hartuv (near the Town of Beit-Shemesh in Israel) in October 2021.

Picture No. 2 is a photograph is a photograph from the front window of a car traveling on the same dirt road shown in picture No. 1 after a heavy truck a day after picture No. 1 was taken and after the dust control substances-solution (DCSS) was applied. The effect of the control of the dust can be seen by comparing the two pictures.

It should be clear that the description of the embodiment set forth in this specification serves only for a better understanding of the invention, without limiting its scope. It should also be clear that a person skilled in the art, after reading the present specification could make adjustments or amendments the above described embodiments that would still be covered by the present invention.

I claim:

1) A dust control substances-solution (DCSS) and the procedure to produce it:
said DCSS comprises of the substances:
propylene glycol,
glycerin
a coloring agent,
a borate substances mixture
a WO-100 mixture (a proprietary liquid silicones mixture),
wood particles
water,
wherein, DCSS is produced in procedure in which:
said coloring agent is mixed with water, forming a solution,
said WO-100 mixture is added to said glycerin, after which said water coloring water solution is added to the WO-100 and glycerin solution,
said mixture of borates is added to said propylene glycol, forming a solution,
said mixture of borates and propylene glycol solution is added to said WO-100, glycerin, and coloring water solution,
said mixture of borates, propylene glycol, WO-100, glycerin, and coloring water solution is mixed with said wood particles, forming said DCSS,
wherein, said DCSS is used by spreading in a layer of DCSS over a dusty surface to be treated for dust control,
wherein, said DCSS layer is wetted after spreading, by spraying water on it,
wherein, water spraying on said DCSS-layer is repeated after the initial spraying as need be, to maintain moisture of said wood particles.

2) The substances in the DCSS layer of claim 1, wherein, said substances are replenished by spraying said DCSS layer with a 20% (by volume) of the solution of the substances of the DCSS without said wood particles and 80% (by volume) water when the color intensity of said coloring agent fades.

3) Coloring agent-of said DCSS of claim 1, wherein the coloring agent is one coloring agent from a group of coloring agents comprising: natural plant-based colorants dyes, azo pigments and dyes, glycoazo dyes, Brilliant Blue FCF and lake colors and dyes.

4) The coloring agent-of said DCSS of claim 1, wherein the fading of the coloring agent in said DCSS layer is in direct correlation with the washout of the other substances of the DCSS from the DCSS layer.

5) The fading of the coloring agent in said DCSS layer of claim 4, wherein said direct coloring agent fading indicates the concentration reduction of the DCSS substances in said layer, as determined by a color chart comparison.

6) The glycerin of claim 1, wherein, the concentration (by weight) of said glycerin in said DCSS is between 25% and 45%.

7) The mixture of borates of claim 1, wherein, the concentration (by weight) of said mixture of borates in said DCSS is between 8% and 12%,

8) The propylene glycol of claim 1, wherein, the concentration (by weight) of said propylene glycol in said DCSS is between 5%-and 10%,

9) The WO-100 solution of claim 1, wherein, the concentration (by weight) in said DCSS is between 0.05% and 0.15%.

10) The water of claim 1, wherein, the concentration (by weight) of said of water in said DCSS is between 0.3% and 0.7%

11) The wood particles of claim 1, wherein, the concentration (by weight) of said wood particles in said DCSS is between 55% and 65%

12) The substances of DCSS of claim 1, wherein, the substances include a water-soluble coloring agent at a concentration (by weight) of between 0.01% and 5%

13) The DCSS of claim 1, wherein, the DCSS is spread in a layer of between land thickness.

14) The wood particles of the DCSS of claim 1, wherein, said wood particles are produced from soft wood.

15) The soft wood particles of claim 14, wherein, said soft wood particles are of various length size particles, ranging from 3 millimeter to 80 millimeters.

16) The DCSS of claim 1, wherein, the DCSS is spread by a commercial beef feed truck.

17) The DCSS of claim 1, wherein, the DCSS is spread by a mulch spread device.

18) The DCSS of claim 1, wherein, the DCSS is spread by a. motor grader

19) The DCSS of claim 1, wherein, the DCSS is spread by a compost spreader
